(19) United States
(12) Patent Application Publication
(10) Pub. No.: US 2018/0257158 A1
(43) Pub. Date: Sep. 13, 2018

(54) METHOD AND DEVICE FOR PRODUCING AND DEBURRING TOOTHINGS

(71) Applicant: EMAG Holding GmbH, Salach (DE)

(72) Inventors: Joerg LOHMANN, Oberndorf (DE); Armin Eberhardt, Amstetten-Schalkstetten (DE); Sven KLUIKE, Esslinger a.N. (DE)

(21) Appl. No.: 15/759,979

(22) PCT Filed: Sep. 14, 2016
(86) PCT No.: PCT/DE2016/000344

§ 371 Date: Mar. 27, 2018

(30) Foreign Application Priority Data
Sep. 17, 2015 (DE) 10 2015 012 190.1
Oct. 6, 2015 (DE) 10 2015 012 908.2

(51) Int. Cl. B23F 17/00; B23Q 39/04

(52) U.S. Cl. CPC B23F 17/008; B23Q 39/04

(57) ABSTRACT

The invention relates to a method for producing and deburring toothings on work pieces (6), comprising two workpiece spindles (3, 3′), comprising a hobbing tool (12) and comprising a deburring device (10), wherein the workpieces (6) are automatically clamped into the workpiece spindles (3, 3′), wherein the workpieces (6) are toothed with the hobbing tool (12) and then deburred, comprising the following method steps: a. receiving an unmachined workpiece (6) in a first loading position (19) via a first workpiece spindle (3) and transporting the workpiece (6) to the hobbing tool (12); b. carrying out a mill cut; c. placing down the workpiece (6) in the first loading position (19) and receiving a further unmachined workpiece (6); d. transporting the workpiece (6) machined with the mill cut to the second loading position (19′); e. receiving the workpiece (6) in the second loading position (19′) via the second workpiece spindle (3′) and transporting the workpiece (6) to the deburring tool (10); f. deburring of the workpiece (6), wherein an intermediate storage (14) for at least one workpiece (6) is provided between the first loading position (19) and the second loading position (19′), wherein the workpiece (6) is moved from the intermediate storage (14) into the loading position (19′), and wherein the method steps e. and f. are carried out in the same time interval in which the method step b. also takes place.

The invention relates to a method and an apparatus for making and deburring gear teeth. A hobbing machine with a carrousel having two workpiece spindles is known from DE 10 2006 019 325. The spindle axes thereof are aligned parallel to a horizontal pivot axis. The two workpiece spindles change stations on rotation of the carrousel. While a workpiece is being machined in one spindle, the other can be loaded. A deburring apparatus is also provided. The arrangement is aimed at avoiding down time by having the loading and deburring take place at the same time. The rigid coupling of the two workpiece spindles is always disadvantageous if loading processes or working steps of different lengths occur. In the case of long mill cuts, for example, the hob head is indeed always working at full capacity, but the workpiece spindle in the loading station has to wait until processing on the parallel spindle has completed.

It is the object of the present invention to shorten the cycle time for making gear teeth. It is also an object of the invention to provide a hobbing machine therefor.

This object is achieved with a method according to claim 1 and a hobbing machine according to claim 5. Advantageous developments constitute the subject matter of the subclaims. The hobbing machine according to the invention has two workpiece spindles that take up the workpieces automatically, transport them for processing, and set them down again. A processing station with a hobbing tool and at least one deburring apparatus are associated with the two workpiece spindles. When teeth are being formed on a workpiece in one workpiece spindle, the other workpiece spindle can be loaded with and deburr a workpiece. Optionally, gear teeth can also be produced with two mill cuts. In another advantageous embodiment, sensors are provided that can monitor the production quality of the workpieces during manufacture. As needed, the angular position of the workpieces can be detected using sensors. The fact that the two tool spindles can move independently of one another enables processing steps of different lengths to be flexibly allocated to the spindles. This enables the capacity utilization of the individual processing units to be increased and the cycle time substantially reduced.

The invention is described in greater detail below on the basis of embodiments.

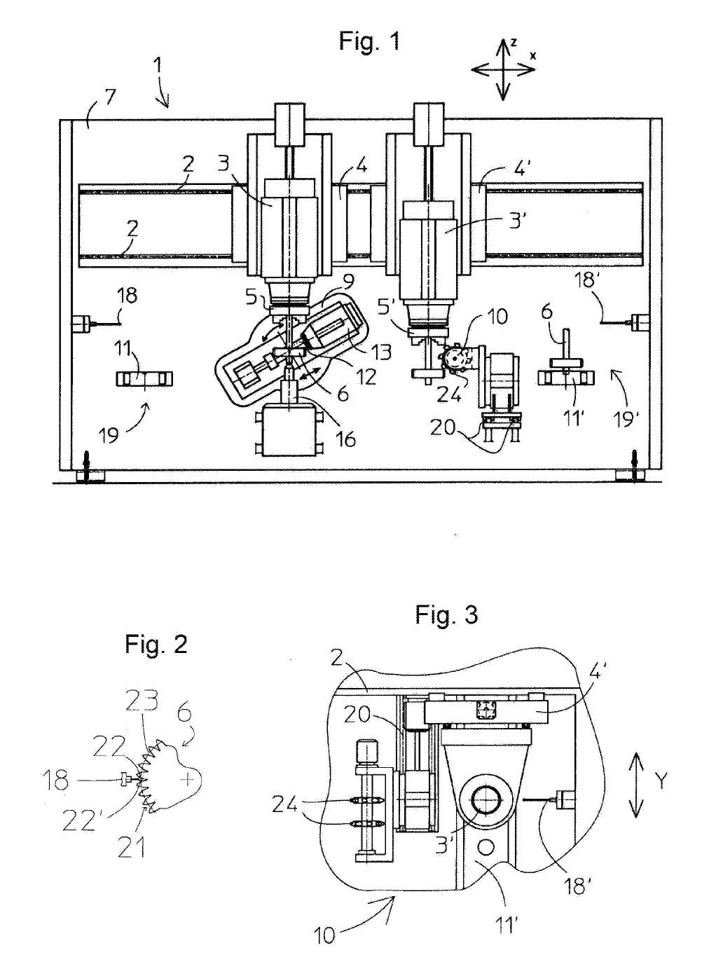

FIG. 1 is a schematic view of a hobbing machine,

FIG. 2 shows the scanning of a workpiece by a sensor,

FIG. 3 shows the deburrer 10 in section from above,

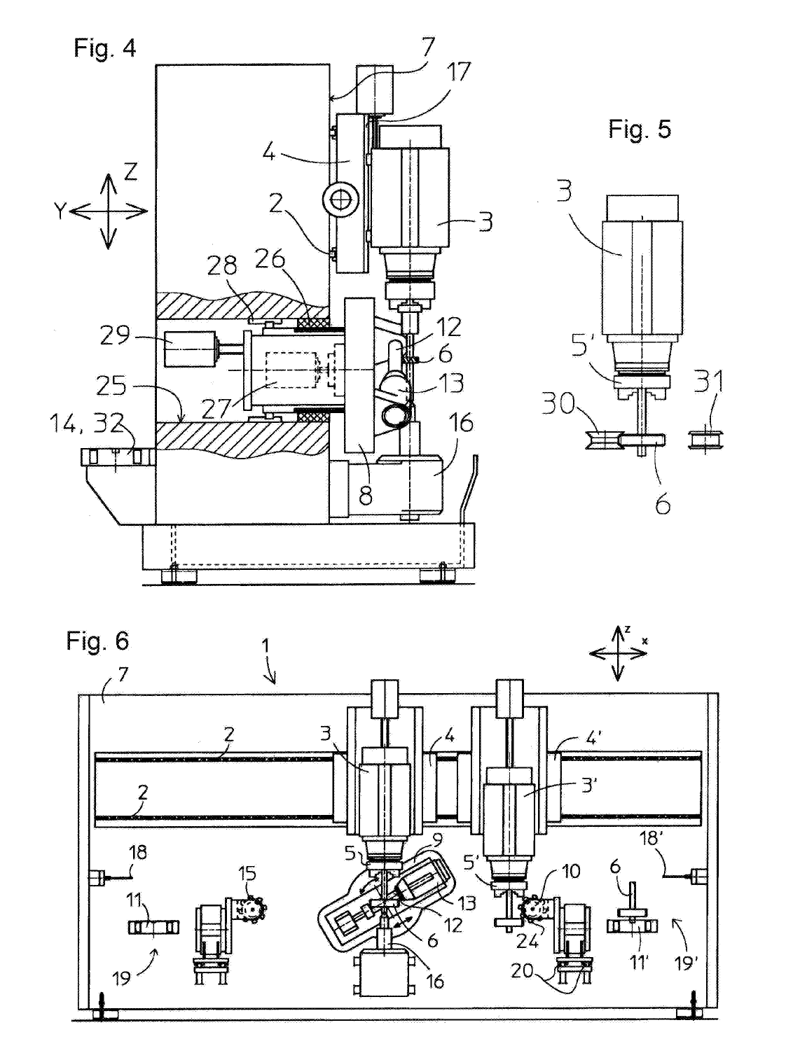

FIG. 4 is a partly sectional side view of the hobbing machine,

FIG. 5 shows an alternative deburrer, and

FIG. 6 shows the hobbing machine according to FIG. 1 with two deburrers.

FIG. 1 shows a hobbing machine according to the invention in a schematic front side view. Two horizontal carriages 4, 4′ are movably guided on a vertical front wall 7 of the machine frame on horizontal guides 2 along the X axis. The two workpiece spindles 3, 3′ can be displaced vertically along the Z axis on the horizontally shiftable carriages 4, 4′. The workpiece spindles 3, 3′ have chucks 5, 5′ on their lower ends for automatically picking up, transporting, and setting down workpieces 6. A tool holder 9 with a hobbing tool 12 is below the guides 2. It is rotated by a drive motor 13. The tool holder 9 can be displaced on a rotatable machining head 8 (not shown in this view) and move the hobbing tool 12 in order to perform displacements along the rotation axis thereof. A tailstock 16 is provided to support the workpieces 6. The deburrer 10 has cutting tools 24 that are similar to disk milling cutters and have helical cutting teeth. They are engaged with the end faces of the workpieces 6. This type of machining has similarities to hobbing. Positioning is done by displacement of the horizontal carriages in the X direction. In addition, the deburrer 10 can be moved along linear guides 20 perpendicular to the X-Z plane (in the Y direction). Conveyors 11, 11′ are provided in loading stations 19, 19′ on either side of the hobbing machine. In order to move workpieces from one loading station to another, the conveyors 11, 11′ are interconnected on the rear side of the machine via a conveyor belt 32 and an intermediate storage 14. According to a first method of the invention, teeth are produced with a mill cut and subsequently deburred using cutting tools 24 similar to disk milling cutters. The machining cycle is started when the workpiece spindle 3 takes up an unmachined workpiece 6 in the loading station 19 and transports it to the hobbing tool 12, for example. The milling is then performed. Subsequently, the workpieces 6 are transported at the rear side of the machine from the loading station 19 into the intermediate storage 14 and from there to the loading station 19′. This prevents the workpiece transport from being slowed on the rear side of the machine. During the same time in which the milling takes place in the workpiece spindle 3, the workpiece spindle 3′ can be loaded in order to deburr a workpiece 6 using a cutting tool 24 with helical cutting teeth.

In the second method according to the invention, a first milling is first performed. The workpiece is then pressure-deburred, after which a second milling is performed. As in the first method, a machining cycle is started when the workpiece spindle 3 receives an unmachined workpiece 6 in the loading station 19 and transports it for example to the hobbing tool 12. A first milling is then carried out there. After the first milling, the workpieces 6 are transported along the rear side of the machine from the loading station 19 via an intermediate storage 14 to the loading station 19′. During the same period of time in which a first milling takes place in the workpiece spindle 3, the workpiece spindle 3′ can be loaded in order to deburr a workpiece 6 that has already been machined with a first milling. While the workpiece spindle 3 receives another unmachined workpiece in the loading station 19, the workpiece spindle 3 moves to the hobbing tool 12 and carries out a second milling there. According to the method according to the invention, the workpiece spindle 3 can be advantageously loaded while the second milling is performed on a workpiece 6 in the workpiece spindle 3′. As shown in FIG. 2, the workpieces 6 can be measured individually or in periodic intervals as needed using sensors 18, 18′.

This is achieved by displacement of the horizontal carriages 4, 4′ along the horizontal guides 2 relative to the respective sensor 18 or 18′. The measuring head is advanced radially into a tooth gap 21. The workpiece 6 is then rotated about its axis in order to determine the exact position of the measurement points 22, 22′ on the pitch circle 23, for example. As needed, the angular position of the workpieces 6 can also be detected using inductive or capacitive sensors (not shown) and taken into account during subsequent machining.

FIG. 3 is a top view of the deburrer 10. It has two rotatable cutting tools 24. Their cutting teeth are mirror symmetrical so that the end faces of the workpieces 6 can be machined on their upper and lower faces in a chuck. In order to change from the upper to the lower face, the cutting tools 24 are moved along the linear guides 20. The workpiece spindle 3′ is shown to the right next to the deburrer 10. It has been moved along the horizontal guides 2 into a position above the conveyor 11′ in order to exchange a completely machined workpiece 6 for an unmachined one.

Advantageously, the workpieces 6 can also be measured with the same positioning accuracy used for the second milling. It is a special advantage that, while one of loading stations 19, 19′ are serviced by the two workpiece spindles 3, 3′, only a single hobbing tool 12 for making the teeth and only one deburrer 10 are allocated.

FIG. 4 is a partly section side view of the hobbing machine. A cavity 25 in the machine frame 1 holds the machining head 8. Since it is recessed the machine frame 1, its spacing from the front wall 7 is especially small. In order to advance the tool 12 radially to the workpiece 6, the machining head 8 is displaced by the feed motor 29. For this purpose, the machining head 8 is movable on one side on rails 28 and additionally in a highly precise hydrostatic guide 26. During machining of helical gear teeth, the tool 12 is inclined according to the helix angle of the teeth. For this purpose, the machining head 8 can be pivoted by the pivot motor 27. The conveyor belt 32 with the intermediate storage 14 connects the loading stations 19, 19′ (not visible in this sectional view) to each other.

FIG. 5 shows an alternative deburrer 10 with a bevel tool 30. As a result, bevels are produced along the teeth on both end faces of the workpiece 6 by reshaping and/or rolling. The secondary burrs occurring as a result on the flat side are also sheared off by such rolling with a deburring tool 31.

FIG. 6 shows the hobbing machines according to FIG. 1 with a second deburrer 15. In this way, a workpiece 6 can also be deburred in the workpiece spindle 3 in the same chuck in which the teeth was produced. Unlike the hobbing machine according to FIG.

1, the workpiece 6 need not be transported to the workpiece spindle 3′ for deburring.

### LIST OF REFERENCE SYMBOLS

5, 5′ chuck
1 machine frame 6 workpiece
2 horizontal guides 7 front wall
3, 3′ workpiece spindle 8 machining head
4, 4′ horizontal carriage 9 tool holder
10 first deburrer 22, 22 measurement points
11, 11′ conveyor 23 pitch circle
12 hobbing tool 24 cutting tool
13 drive motor 25 cavity
14 intermediate storage 26 hydrostatic support
15 second deburrer 27 pivot motor
16 tailstock 28 rail
17 vertical guides 29 feed motor
18, 18′ sensor 30 bevel tool
19, 19′ loading station 31 deburring tool
20 linear guides 32 conveyor belt
21 tooth gap

1. A method of making and deburring gear teeth on workpieces using
first and second workpiece spindles,
a hobbing tool, and
a first deburrer
the method comprising the following steps:
a) picking up a n first unmachined workpiece in a first loading station with a first workpiece spindle and transporting the picked-up first workpiece with the first spindle to the hobbing tool,
b) machining teeth into the first workpiece with the hobbing tool by a mill cut as a first milling,
c) setting down the machined first workpiece in the first loading station and picking up a n second unmachined workpiece.
d) conveying the machined first workpiece from the first station to a second loading station,
e) picking up the machined first workpiece in the second loading station with the second workpiece spindle and conveying the machined first workpiece from the second station to a first deburrer,
f) deburring the first machined workpiece, and
g) during method steps e) and f) machining teeth into the second unmachined workpiece as in method step b) with the hobbing tool as a second milling.

2. The method defined in claim 1, further comprising the step of:
detecting an angular position of the workpieces before method step e).

3. The method defined in claim 1, further comprising, after method step f), the following method steps:
g) conveying the unmachined second workpiece to the hobbing tool,
h) carrying out the second milling,
i) setting down the machined second workpiece in the second loading station, method step h) being carried out synchronously with method step a).

4. The method defined in claim 3, wherein method steps a) and h) are carried out at the same time.

5. A hobbing machine comprising:
a machine frame defining first and second loading stations;
first and second workpiece spindles on the frame for automatically picking up, transporting, rotating and setting down workpieces;
a machining head with a tool holder and a rotationally drivable hobbing tool;
means for advancing the machining head radially to the workpiece;
a first deburrer on the frame;
a hobbing tool on the frame;
means including horizontally shiftable carriages on the frame for moving the workpiece spindles relative to the machine frame along an X axis into a working range of the hobbing tool and along a Z axis; and
means for moving the first workpiece spindle between the first loading station and the hobbing tool and the second workpiece spindle back and forth between the second loading station, the first deburring tool, and the hobbing tool.

6. The hobbing machine defined in claim 5, further comprising:
a second deburrer on the frame, the means for moving shifting the first workpiece spindle to the second deburrer.

7. The hobbing machine defined in claim 5, further comprising:
a single tailstock for the first and second workpiece spindles.

8. The hobbing machine defined in claim 5, further comprising
a conveyor belt for transporting workpieces from the first loading station to the second loading station.

9. The hobbing machine defined in claim wherein the first and second deburrers have rotationally driven cut ting teeth.

10. The hobbing machine defined in claim 6, wherein the deburrers have bevel tools and deburring tools.
